(19) United States
(12) Patent Application Publication
(10) Pub. No.: US 2009/0316961 A1
(43) Pub. Date: Dec. 24, 2009

(54) METHOD FOR TAGGING IMAGE CONTENT

(75) Inventors: Federico Gomez Suarez, Redmond, WA (US); Anthony DiCola, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,762

(22) Filed: Jun. 21, 2008

(51) Int. Cl. G06K 9/00

(52) U.S. Cl. 382/118

(57) ABSTRACT

A computer based method for facilitating tagging of an input image is disclosed. The method includes receiving an input image which has a content including at least a facial image or a plurality of facial images. From this input image, facial recognition techniques are used to identify where in the image the faces are located. When a facial image is detected, the facial image may be displayed to the user as an individual facial image which substantially consists of a face. This display helps facilitate tagging of the individual facial image and also tagging of the input image. A user may input a tag for the individual facial image and the input image. Also, a user may be presented with contact information which is likely to include a name of a person which can be selected as a tag for the individual facial image and/or also the input image.

### BACKGROUND

This Background is intended to provide the basic context of this patent application and it is not intended to describe a specific problem to be solved.

With the evolution of computers, user interfaces have also evolved. Initially, computers had an electronic user interface which consisted of a line prompt. To effectively interface with the computer users were expected to know a computer specific language or script. Such knowledge required the user to have a computer-directed technical education. Computer interfaces became more user friendly with the advent of windows type user interfaces, such as icons, point and click methods, menus, task panes, tabs, scroll buttons, pop-up windows, toggles, etc. User interfaces help a user operate a new application or program which is aided by a computer system.

Computer systems are used to input, store, and produce data. Computer systems may also interoperate with many different peripheral devices or network devices which may be coupled to the computer system. Such devices include other networks, the internet, servers, clients, printers, game devices, video cameras, and digital video cameras.

Shortly after the introduction of digital cameras came the ability for users to store their input images onto their own personal computers. Users could easily download their images to their computers for storage. When the amount of images stored becomes large, these images become difficult to organize. The organization of these images is a cumbersome task which involves viewing each photo and storing each photo with a descriptive file name. If the file name is descriptive, then the user will have an easier time finding the specific image later. Sometimes the description a user selects for the file name will not be descriptive enough for later retrieval of the image.

To retrieve a specific image at a later time, a user must recall which folder or filename they used to store the image. Tagging is something that makes this retrieval process easier. Tagging associates data with tags or words that are used to characterize or label the contents of the data. Additionally, tags may be attached to data by different people so that a more descriptive tagging of the data can occur which might not have been thought of by the original user of the data.

### SUMMARY

One problem an embodiment of the present disclosure solves is to facilitate tagging an image.

An embodiment of the disclosure includes a computer based method for facilitating tagging of an input image, the method including receiving an input image having a first content including at least a facial image; producing an individual facial image having a second content substantially comprising an individual face of the individual facial image; and displaying the individual facial image or the individual face.

An embodiment of the disclosure includes a computer program product that includes a computer medium having a sequence of instructions which, when executed by a processor, causes the processor to execute a process for facilitating tagging content of an input image, the process including receiving an input image having a first content including at least a facial image; producing an individual facial image having a second content substantially comprising an individual face of the individual facial image; and displaying the individual facial image or the individual face.

An embodiment of the disclosure includes a user interface module including an input image receiving module configured to receive an input image having a first content including a plurality of facial images; a facial image production module configured to produce an individual facial image having a second content substantially comprising an individual face of the individual facial image; a facial display module configured to display the individual facial image, wherein the facial display module is further configured to display the input image along with the individual facial image; a contact display module configured to display contact information configured to be likely associated with the individual facial image as a tag option; a tag data receiving module configured to receive an input tag data configured to be associated with the individual facial image; a coordinate identification module configured to identify coordinate information of the facial image; a facial image producing module configured to produce an individual facial image according to the coordinate information, from the input image; and a tag association module configured to associate the input tag based on the individual facial image, and configured to associate the input tag with the input image.

### BRIEF DESCRIPTION OF THE DRAWINGS

FIG. 1 is a block diagram of a general purpose computing device suitable for hosting an image content tagging user interface module;

FIG. 2 is an embodiment of the user interface (UI) as the interface would appear on a computer display screen;

FIG. 3 is a diagram showing an embodiment of the architecture of the UI used for tagging image content.

FIG. 4 is a flow chart of an embodiment of a method of interfacing with a user to enable the user to tag individual facial images of an input image.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

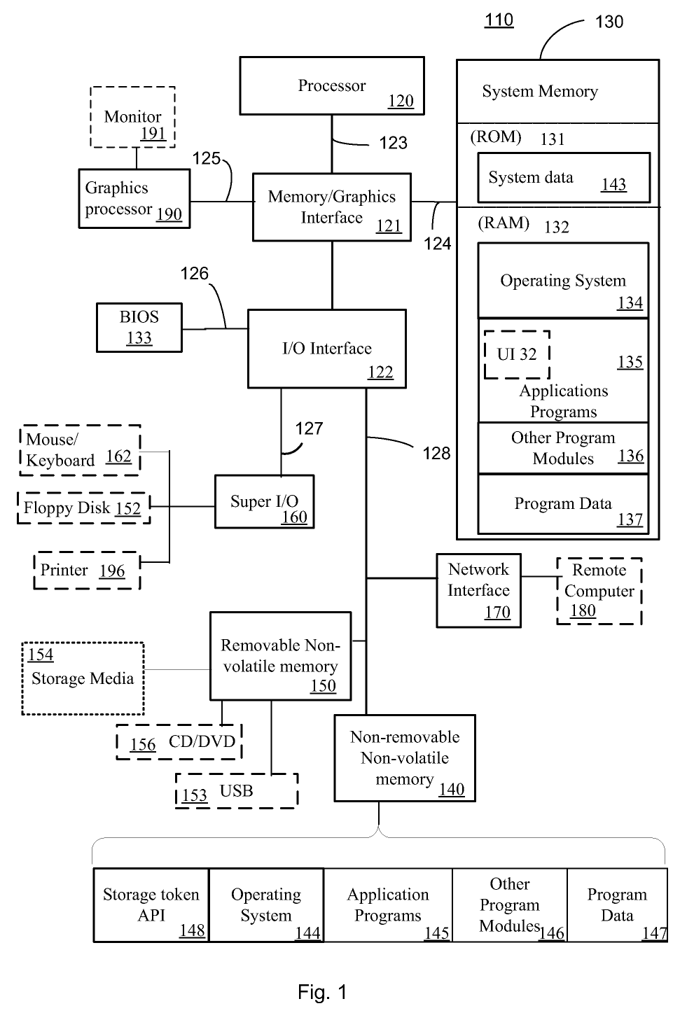

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport™ architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137. An embodiment of the disclosure may have the user interface module 32 stored in the applications programs 135 storage area. The user interface system 30 may be stored in the applications program storage area 135 also, or may be distributed throughout other storage devices on the computer system 110 or across a network. The user interface module 32 may also be stored in other storage locations of the computer system 110 or across a network.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a bus 127, such as a low pin count (LPC) bus, in some embodiments. Various embodiments of the super I/O chip 160 are widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

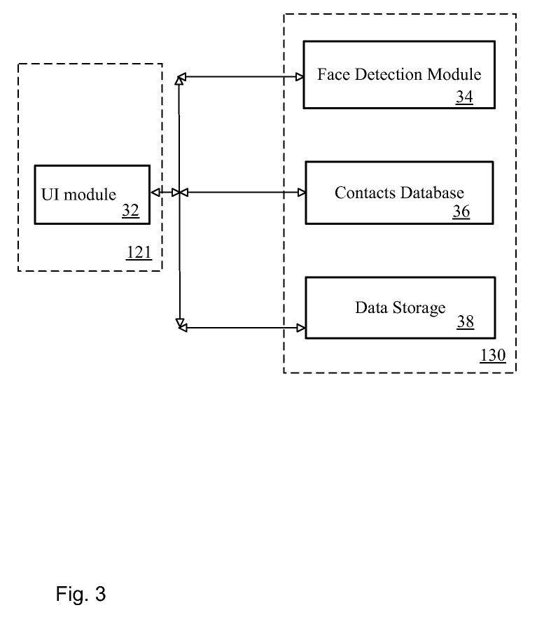

The computer 110 may also include other removable/non-removable, volatile/nonvolatile computer storage media. By way of example only, FIG. 1 illustrates a hard disk drive 140 that reads from or writes to non-removable, nonvolatile magnetic media. The hard disk drive 140 may be a conventional hard disk drive or may be similar to the storage media described below with respect to FIG. 3.

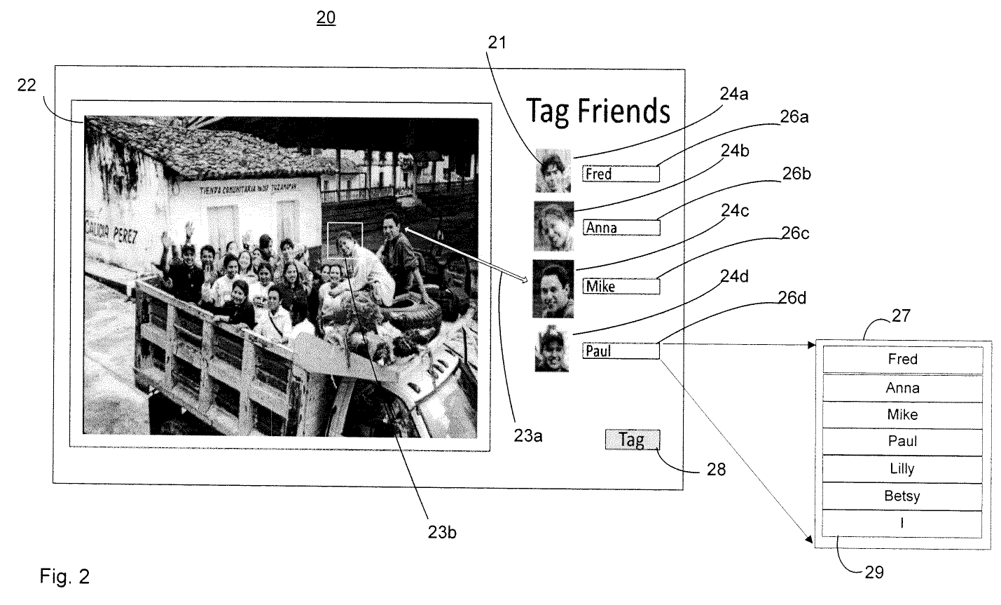

Removable media, such as a universal serial bus (USB) memory 153, firewire (IEEE 1394), or CD/DVD drive 156 may be connected to the PCI bus 128 directly or through an interface 150. A storage media 154 similar to that described below with respect to FIG. 2 may coupled through interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet. The remote computer 180 may also represent a web server supporting interactive sessions with the computer 110.

In some embodiments, the network interface may use a modem (not depicted) when a broadband connection is not available or is not used. It will be appreciated that the network connection shown is exemplary and other means of establishing a communications link between the computers may be used.

The way a user interfaces with a computer has evolved. Initially, computers had an electronic user interface which was a line prompt where users were expected to know a computer specific language or script. Such knowledge required the user to have a computer directed technical education in order to interface with a computer. Computer interfaces became more user-friendly with the advent of windows type user interfaces, such as icons, point and click, menus, task panes, tabs, scroll buttons, pop-up windows, toggles, etc.

FIG. 2 illustrates an embodiment of the disclosed user interface. An image 22 may be input by a user or accessed via the computer 110 or via the input output (I/O) interface 122 from a network or other peripheral device. The image 22 is then processed so that individual facial images are identified. Identification of the individual facial images is accomplished via face recognition software techniques.

Face recognition software techniques include elementary and statistical techniques that look for facial patterns within an image. One example of a face recognition technique is the Viola-Jones facial recognition technique. Also, 3-dimension model variations of facial recognition techniques are able to be used with embodiments of this invention. For example, if a person's individual facial image is not pictured straight on, but rotated off of an axis, then modifications to the facial recognition techniques or other facial recognition techniques capable of such off axis recognition are also included for use by the disclosed UI.

After an individual face is recognized from the input image, a border is determined which would contain at least most of the facial image. Coordinates indicating the border location are identified. Many different ways of specifying the border coordinates are available. For example, x-y coordinates of four corners of the border may be determined. Also, a center coordinate with a radius, center-coordinates with an associated square border notation, etc. Those of ordinary skill in the art will appreciate the different information coding techniques available to communicate the detected individual facial image from the input image and/or generate an individual facial image from the input image.

These individual face images may be output to the user interface 20 as shown along with the input image 22. The user interface may be presented to the user via the monitor 191. For example, four individual facial images 24 (24a-d) are shown on the monitor 191. These individual facial images were extracted from the input image 22. These individual facial images 24 are presented to the user in the example embodiment of the user interface shown in FIG. 2.

To the right of each of the individual facial images is a click tab 26 (26a-d) that lists a group of names as shown as a blown up image of what tag 26d may have as choices from the, for example, pop-up options list 27. These names are tag options from which the user may choose. The user may select one of the group of names as a tag 26 (26a-d) for the respective individual face image 24 (24a-d) or the user may see that the correct tag is not listed and the user may insert the correct new tag 29 into the list 27. If the user inserted a new tag, then this new tag 29 may be sent to the UI system 30 (FIG. 3).

An example embodiment of the UI system 30 is shown in FIG. 3. A UI module 32 may retrieve the input image 22 from the user or from another storage unit of the local computer 110, remote computer 180, or via the computer interfaces (122, 160 170), etc, or other remote peripheral devices. The UI module 32 may be stored at the memory/graphics interface 121 of a computer system or at the system memory, for example, at the Application Programs storage 135. As discussed above, the input image 22 may be retrieved from any one of the memory 130, memory 140, or other peripheral devices, such as a floppy disk 152, printer 196, camera device, removable memory 150, CD/DVD 156, USB 153, remote computer 180, etc., and any device which may communicate the input image via the I/O interface 122.

The face detection module 34 may reside as a program on the computer system 110 or may be coupled to the computer system 110. As discussed above, the face detection module 34 performs face detection of an image to determine if a person's face is found in the input image 22. Examples of face detection techniques include, but are not limited to the following disclosures in U.S. patents/publications: U.S. Pat. No. 7,368,686; “Robot Apparatus, Face Recognition Method, and Face Recognition Apparatus,” Yokono et al.; U.S. Pat. No. 7,362,886, “Age-Based Face Recognition,” Rowe et al.; U.S. Pat. No. 7,308,133, “System and Method of Face Recognition Using Proportions of Learned Model,” Gutta et al.; U.S. Pat. No. 7,295,687, “Face Recognition Method Using Artificial Neural Network and Apparatus Thereof,” Kee et al.; U.S. Pat. No. 7,221,809, “Face Recognition System and Method,” Geng; U.S. Pat. No. 7,203,346, “Face Recognition Method and Apparatus Using Component-Based Face Descriptor,” Kim et al.; U.S. Pat. No. 7,177,450, “Face Recognition Method, Recording Medium Thereof and Face Recognition Device,” Tajima; U.S. Pat. No. 7,155,037, “Face Recognition Apparatus,” Nagai et al.; U.S. Pat. No. 7,142,697, “Pose-Invariant Face Recognition System and Process,” Huang et al.; U.S. Pat. No. 7,139,738, “Face recognition using evolutionary algorithms,” Philomin et al.; U.S. Pat. No. 7,127,087, “Pose-Invariant Face Recognition System and Process,” Huang et al.; U.S. Pat. No. 7,095,879, “System and Method for Face Recognition Using Synthesized Images,” Yan et al.; U.S. Pat. No. 7,054,468, “Face Recognition Using Kernel Fisherfaces,” Yang; U.S. Pat. No. 6,975,750, “System and Method for Face Recognition Using Synthesized Training Images,” Yan et al.; U.S. Pat. No. 6,947,579, “Three-Dimensional Face Recognition,” Bronstein et al.; U.S. Pat. No. 6,944,319, “Pose-Invariant Face Recognition System and Process,” Huang et al.; U.S. Pat. No. 6,345,109, “Face Recognition-Matching System Effective to Images Obtained in Different Imaging Conditions,” Souma et al.; U.S. Pat. No. 6,301,370, “Face Recognition From Video Images,” Steffens et al.; U.S. Pat. No. 6,111,517, “Continuous Video Monitoring Using Face Recognition For Access Control,” Atick et al.; U.S. Pat. No. 6,108,437, “Face Recognition Apparatus, Method, System and Computer Readable Medium Thereof,” Lin; U.S. Pat. No. 7,324,671, “System and Method for Multi-View Face Detection,” Li et al.; U.S. Pat. No. 7,315,631, “Real-Time Face Tracking in a Digital Image Acquisition Device,” Corcoran et al.; U.S. Pat. No. 7,050,607, “System and Method for Multi-View Face Detection,” Li et al.; U.S. Patent Publication No. 2002/0102024, “Method and System for Object Detection in Digital Images,” Jones et al., all of which are incorporated herein by reference.

Examples of face detection techniques also include, but are not limited to the following non patent literature: Ming-Hsuan Yang, David Kriegman, and Narendra Ahuja, “Detecting Faces in Images: A Survey,” IEEE Transactions on Pattern Analysis and Machine Intelligence (PAMI), vol. 24, no. 1, pp. 34-58, 2002; “Recent Advances in Face Detection,” IEEE ICPR 2004 Tutorial, Cambridge, United Kingdom, Aug. 22, 2004; “Recent Advances in Face Detection,” IEEE ICIP 2003 Tutorial, Barcelona, Spain, Sep. 14, 2003; Viola, P., Jones, M., “Rapid object detection using a boosted cascade of simple features,” Proceedings of the 2001 IEEE Computer Society Conference on Computer Vision and Pattern Recognition, 2001, pp. 511-518; Keren, D., Osadchy, M., Gotsman, C., “Antifaces: A Novel, Fast Method for Image Detection,” IEEE Transactions on Pattern Analysis and Machine Intelligence, v.23 n.7, July 2001, pp. 747-761; Stan Z. Li, Long Zhu, ZhenQiu Zhang, Andrew Blake, HongJiang Zhang, Harry Shum, “Statistical Learning of Multi-view Face Detection,” Proceedings of the 7th European Conference on Computer Vision-Part IV, May 28-31, 2002, pp. 67-81; Romdhani, S., Torr, P., Scholkopf, B. & Blake, A., “Computationally efficient face detection,” Proceedings of the 8th International Conference on Computer Vision, 2001; and any of their related U.S. patents and patent publications all of which are incorporated herein by reference.

After the face detection module 34 detects an individual face from the input image 22, the face detection module 34 produces a coordinate or other identification information for indicating where the individual facial image 24 is found in the input image 22. The identification information may be used to locate the individual facial image 24 and send the individual facial image 24 to the UI module 32.

Alternatively, the face detection module 34 may immediately produce the individual facial image 24 as a result of the face recognition technique used by the face detection module 34. Also, the coordinate information may be used to present an indication, such as an arrow 23a or a highlighted border 23b, of where the individual facial image 24 is found in the input image 22.

After one or more of the individual facial images 24 is detected and sent to the UI module 32. The UI device displays the individual facial image 24 or the individual face 21 which is substantially comprising the individual facial image 24 to the user, as shown in FIG. 2. The user may then indicate a tag 26 (26a-d) for each individual facial image 24. The UI may also retrieve user contact information from the contacts database 36. Alternatively, the UI may display the user contact information so that the user selects a tag 26 for the individual facial image 24 from amongst the available contact information.

Once the user has entered or selected the appropriate tag 26, the user may store the tag 26 by selecting the Tag button 28. The UI may begin a tagging procedure which would cause the tag 26 to be stored with the individual facial image 24, for example data storage unit 38. Alternatively, the UI may immediately store the tag 26 with the associated facial image 24.

Additionally, the tagging associated with the individual facial images 24 generated from the input image 22, may also be used to tag the input image 22.

Additionally, the individual facial image 24 and/or the input image 22 may be increased or decreased in size, or zoomed in or zoomed out with, for example, a user interface which is hidden until the user moved moves the pointer over the individual facial image.

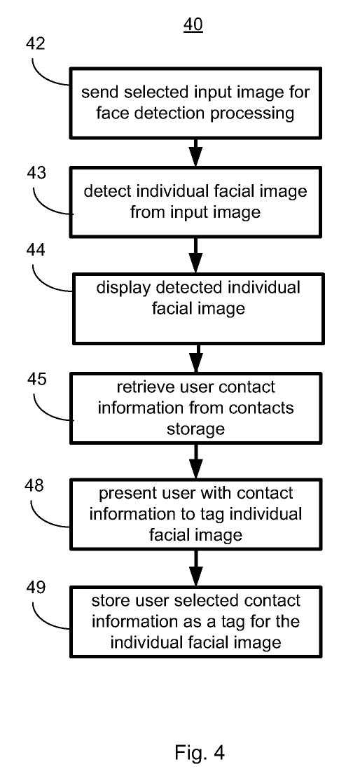

A flow diagram of an embodiment of the combination of the individual facial image generating procedure and the individual facial image tagging procedure is shown in FIG. 4. These procedures together can be used to tag an individual facial image 24, and may also be used to tag the associated input image 22.

The user may provide as input an input image 22. The input image 22 may also be input via an automated technique, such as software designed to search for image data. The image data may be searched amongst the computer system itself 110 or via the I/O interface 122 in order to find image data from other devices.

The input image 22 may or may not contain individual facial images. To determine if the input image 22 does contain an individual facial image 24, the UI may send this input image to a face detection module (42). The face detection module detects individual facial images from the input image content (43). These images 24 or the individual face 21 are then displayed to the user via the UI (44).

The user, upon presentation of these individual facial images 24, may input a tag 26 to be associated with each individual facial image. Alternatively, the UI may retrieve user contact information (45) and display the user contact information to the user (46) so that the user can select from the user contact information in order to tag the individual facial images 24 with the tags 26 (49). In addition, the same selected tag 26 information can also be used to tag the input image 22. Also, a user may input a new tag 29 to tag the individual facial image and/or the input image.

We claim:

1. A computer based method for facilitating tagging of content of an input image, the method comprising:
receiving an input image having a first content including at least a facial image;
producing an individual facial image having a second content substantially comprising an individual face of the individual facial image; and
displaying the individual facial image or the individual face.

2. The method of claim 1, further comprising:
displaying the input image along with the individual facial image in an image window; and
providing zooming capabilities on the individual facial image and a location substantially encompassing the facial image in the input image.

3. The method of claim 1, further comprising:
displaying contact information configured to be associated with the individual facial image as a tag option in a pop-up window, the pop-up window configured to show a next contact information when a pointer is located at an end of a list of the contact information.

4. The method of claim 1, further comprising:
displaying contact information configured to likely be associated with the individual facial image as a tag option in a pop-up window, the pop-up window configured to scroll through contact information.

5. The method of claim 1, further comprising:
receiving tag data from a pop-up window selection, the tag data configured to be associated with the individual facial image.

6. The method of claim 1, wherein the first content of the input image has a plurality of facial images.

7. The method of claim 1, further comprising:
identifying coordinate information of a border of the facial image; and
producing an individual facial image according to the coordinate information, from the input image.

8. The method of claim 1, further comprising:
associating a tag from a list of contact information with the individual facial image.

9. The method if claim 1, further comprising:
indicating a location in the input image, where the individual facial image is located.

10. A computer program product that includes a computer medium having a sequence of instructions which, when executed by a processor, causes the processor to execute a process for facilitating tagging content of an input image, the process comprising:
receiving an input image having a first content including at least a facial image;
producing an individual facial image having a second content substantially comprising an individual face of the individual facial image; and
displaying the individual facial image or the individual face.

11. The process of claim 10, further comprising:
displaying the input image along with the individual facial image.

12. The process of claim 10, further comprising:
displaying contact information configured to be associated with the individual facial image as a tag option.

13. The process of claim 10, further comprising:
displaying contact information configured to likely be associated with the individual facial image as a tag option.

14. The process of claim 10, further comprising:
receiving tag data configured to be associated with the individual facial image.

15. The process of claim 10, wherein the first content of the input image has a plurality of facial images.

16. The process of claim 10, further comprising:
identifying coordinate information of the facial image; and
producing an individual facial image according to the coordinate information, from the input image.

17. The process of claim 10, further comprising:
associating a tag with the individual facial image.

18. The process if claim 10, further comprising:
associating a tag based on the individual facial image, and
associating the tag with the input image.

19. A user interface module comprising:
an input image receiving module configured to receive an input image having a first content including a plurality of facial images;
a facial image production module configured to produce an individual facial image having a second content substantially comprising an individual face of the individual facial image;
a facial display module configured to display the individual facial image, wherein the facial display module is further configured to display the input image along with the individual facial image;
a contact display module configured to display contact information configured to be likely associated with the individual facial image as a tag option;
a tag data receiving module configured to receive an input tag data configured to be associated with the individual facial image; and
a tag association module configured to associate the input tag with the individual facial image, and configured to associate the input tag with the input image.

20. The user interface module of claim 19, further comprising:
a location indication module configured to indicate where in the input image the individual facial image is located.
